(19) United States
(12) Patent Application Publication
(10) Pub. No.: US 2024/0236269 A9
(43) Pub. Date: Jul. 11, 2024

(54) REMOTE MANAGEMENT OF CLIENT DEVICES FOR VIRTUAL CONFERENCES BASED ON CLIENT DEVICE CONTEXT

(71) Applicant: Zoom Video Communications, Inc., San Jose, CA (US)

(72) Inventor: Patrick John Jensen, Fresno, CA (US)

(21) Appl. No.: 17/973,218

(22) Filed: Oct. 25, 2022

(51) Int. Cl. H04N 7/15; H04L 12/18; H04N 7/14

(52) U.S. Cl. CPC H04N 7/152; H04L 12/1818; H04L 12/1822; H04L 12/1863; H04N 7/147

(57) ABSTRACT

One example method for remote management of client devices for virtual conferences based on client device context includes receiving, by a virtual conference provider, a connection request from a first client device executing virtual conference client software; determining a context associated with the first client device based on the request; generating a manifest associated with the context, the manifest comprising one or more configuration settings associated with the virtual conference client software; and transmitting the manifest to the client device.

### FIELD

The present application generally relates to virtual conferencing and more particularly relates to remote management of client devices for virtual conferences based on client device context.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for remote management of client devices for virtual conferences based on client device context;

FIGS. 3A-3B show an example system for remote management of client devices for virtual conferences based on client device context;

FIGS. 4A-4C and 5 show example graphical user interfaces usable with systems and methods for remote management of client devices for virtual conferences based on client device context;

FIGS. 6-7 show example methods for remote management of client devices for virtual conferences based on client device context; and

FIG. 8 shows an example computing device suitable for use with example systems and methods for remote management of client devices for virtual conferences based on client device context.

### DETAILED DESCRIPTION

Examples are described herein in the context of remote management of client devices for virtual conferences based on client device context. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

During a virtual conference, participants may engage with each other to discuss any matters of interest. Typically, the participants will interact in a virtual conference using a camera and microphone, which provides video and audio streams (each a “media” stream; collectively “multimedia” streams) that can be delivered to the other participants by the virtual conference provider and be displayed via the various client devices' displays or speakers. In a typical meeting, users will be presented with views of different participants in windows within a graphical user interface (“GUI”). As different participants speak, their participant window may be highlighted, change size or position, or otherwise be emphasized so that others in the virtual conference know which participant is talking.

In some examples, however, participants may connect to a virtual conference provider from areas with limited network capabilities or in environments that are regulated by state, regional, national, or international authorities, such as airplanes or automated vehicles. In some such situations, a client device may have difficulty connecting to a virtual conference provider or may need to operate with reduced functionality to comply with applicable laws or regulations. To address these issues and to help ensure the client device operates in a compliant manner, when the client device executes virtual conference client software and attempts to connect to the virtual conference provider, it may transmit a request to connect. The request may carry with it certain information, whether within the body of the request or in network protocol information associated with the request. For example, the request may include information identifying a network service provider, a network address, a location, an identification of available audio or video equipment, or network traffic information such as bandwidth, latency, or jitter.

After receiving the request to connect, the virtual conference provider may determine that the client device is operating in a setting that requires reduced or mandated capabilities. For example, on a commercial airliner, regulations may require the use of certain audio or visual equipment or it may restrict operation of the client device during crew or safety announcements. Thus, to adjust the configuration of the client device to comply with regulations or otherwise accommodate the client device's context, the virtual conference provider generates a manifest that contains configuration information based on that context. It then provides the manifest to the client device, which extracts configuration parameters and configures the virtual conference client software based on the configuration parameters. For example, the manifest may require that the virtual conference client software disable audio or video capabilities or it may require specific video resolution or data rate. The configuration is automatically applied to the virtual conference client software, which may disable certain user interface controls such as by greying the relevant controls or selecting a particular video or audio encoder. It may also cause other functionality to be activated, such as by providing a real-time transcript or activating or opening a chat window for the user.

In addition to providing the manifest to the client device, the virtual conference provider may also provide status information for the client device's user to indicate their status, such as being on an airplane or train or other mode of transportation. By providing this information, other users can be made aware of the status, which may enable more efficient communication.

Such functionality can enable virtual conferencing in situations that may otherwise restrict or prohibit users from engaging in virtual conferences. By determining the client device's context, the virtual conference provider can select and provide temporary configuration requirements to the client device to both enable its user to participate in virtual conference, but also to comply with relevant laws or regulations. The configuration settings can later be removed or adjusted if the context changes, such as after the user returns to a more typical conferencing environment.

This illustrative example is given to introduce the reader to the general subject matter discussed herein and the disclosure is not limited to this example. The following sections describe various additional non-limiting examples and examples of remote management of client devices for virtual conferences based on client device context.

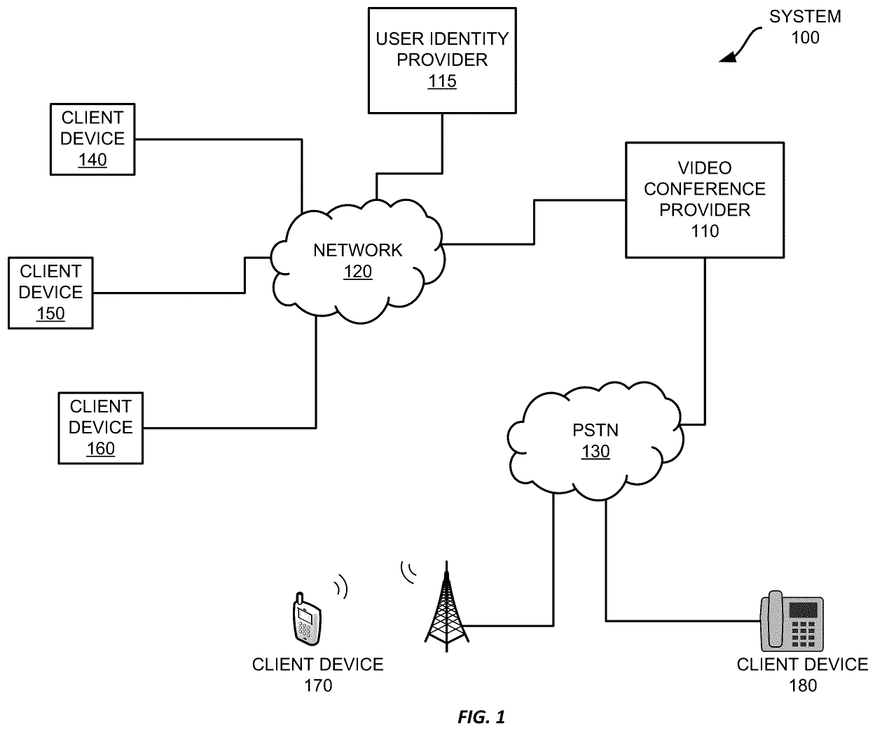

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

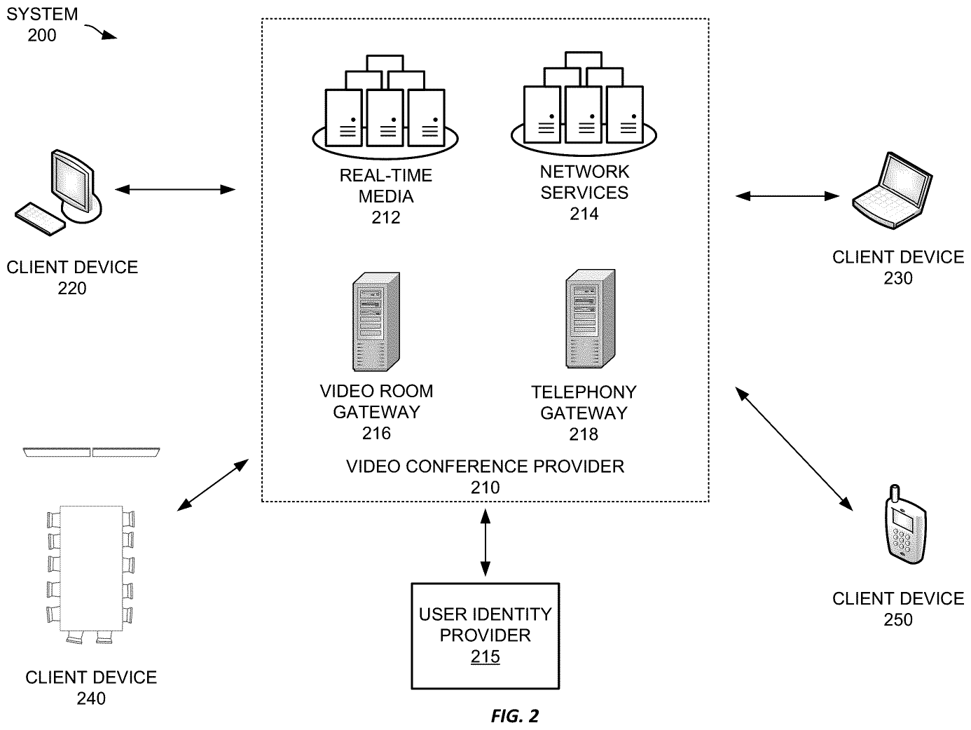

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

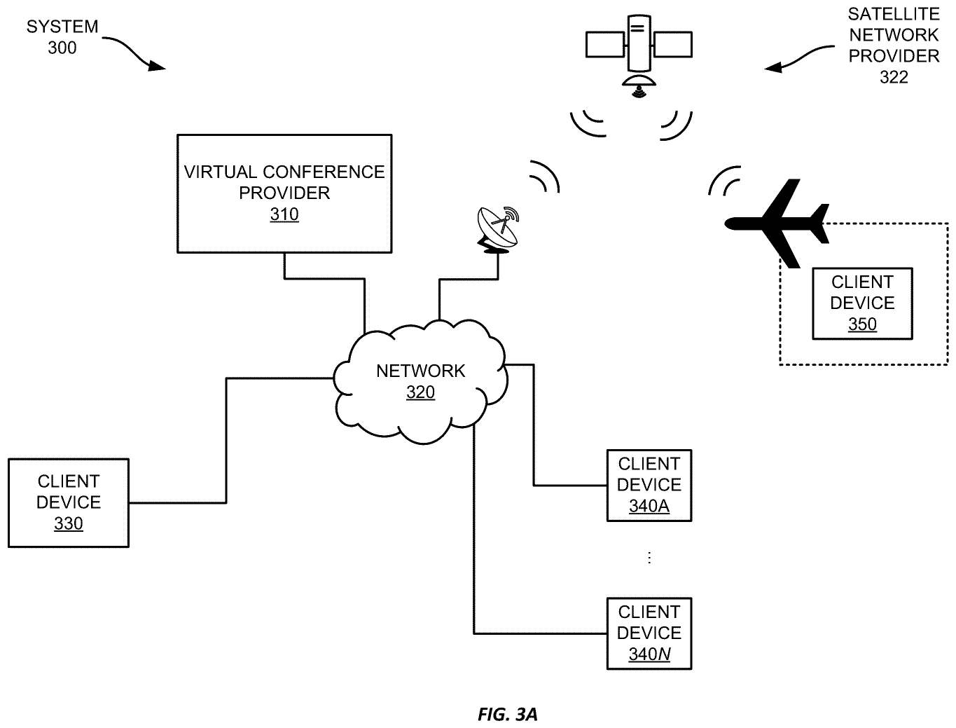

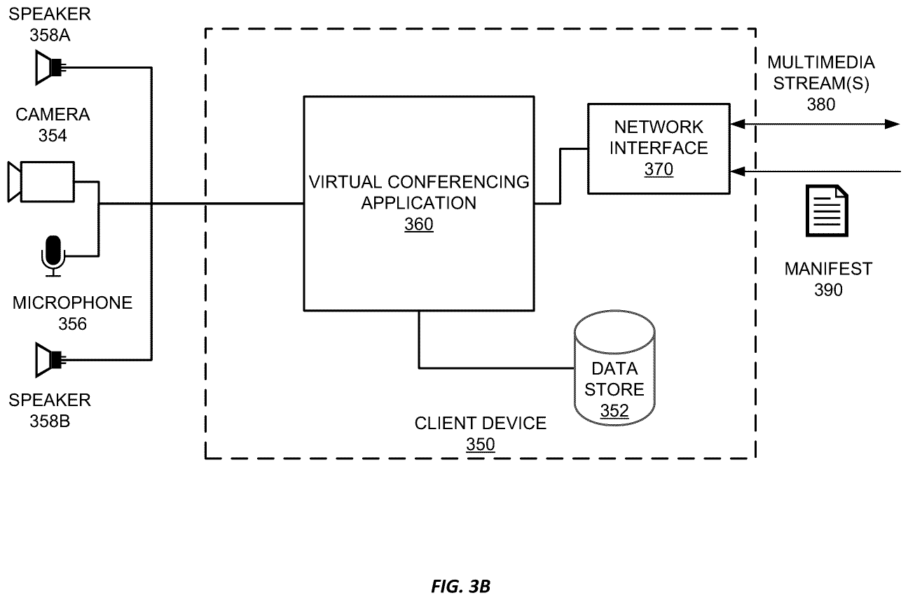

Referring now to FIGS. 3A-3B, FIG. 3A shows an example system 300 for remote management of client devices for virtual conferences based on client device context. The system 300 includes a virtual conference provider 310, which can be connected to multiple client devices 330, 340a-n, 350 via one or more intervening communication networks 320. In this example, the communications network 320 is the internet, however, any suitable communications network or combination of communications network may be employed, including LANs (e.g., within a corporate private LAN), WANs, etc. In this example, one client device 350 is depicted as operating on an aircraft and connected to the communications network 320 via a satellite network provider 322.

Each client device 330, 340a-n, 350 executes virtual conference software that connects to the virtual conference provider 310 and joins a meeting. During the meeting, the various participants (using virtual conference software or “client software” at their respective client devices 330, 340a-n, 350) are able to interact with each other to conduct the meeting, such as by viewing video feeds and hearing audio feeds from other participants, and by capturing and transmitting video and audio of themselves.

Client device 330, 340a-n, 350 may join virtual conferences hosted by the virtual conference provider 310 by connecting to the virtual conferences provider and joining a desired virtual conference, generally as discussed above with respect to FIGS. 1-2. Once the participants have joined the conference, they may interact with each other by exchanging audio and video feeds. However, as will be discussed in more detail below, the client device 350 operated by a user while riding an aircraft may be remotely configured by the virtual conference provider 310 to operate with reduced capabilities or with certain features mandatorily activated or deactivated based on the determined context.

Referring now to FIG. 3B, FIG. 3B shows an example client device 350 from FIG. 3A. The client device 350 executes a software client, referred to as the virtual conferencing application 360 in this example. The virtual conferencing application 360 receives audio and video data from a microphone 356 and a camera 354, respectively, connected to the client device 350. During a virtual conference, the virtual conferencing application 360 encodes the received audio and video data and transmits them to the network as multimedia streams 380 using a network interface 370. In addition, the virtual conferencing application 360 receives multimedia streams 380 from the virtual conference provider 310, which were initially generated by other client devices, e.g., client devices 330, 340a-n, participating in the virtual conference. In addition, the client device 350 can also receive manifests 390 from the virtual conferencing provider 310, which can include configuration settings for the client device 350, as will be discussed below.

While this example is in the context of a client device 350 located on a commercial aircraft, it can also be used with client devices in other contexts, such as when located on a rail line, in a bus, in a car, in an automated vehicle, on boat or ship, or other context. Further, other contexts may any of a variety of techniques to connect to the virtual conference provider 310, including satellite (as discussed above), cellular, 5G, or others.

When the user launches the client software 360, it contacts the virtual conference provider 310 and requests to connect, which may involve a login process for the user, such as by providing a username and password. The request sent by the client software 360 is received by the virtual conference provider 310, which can detect certain information about the client device's context. For example, the virtual conference provider 310 may receive a network address, such as an internet protocol (“IP”) address corresponding to the client device 350; network configuration parameters for the client device, such as bandwidth and network interface; network performance information, such as latency, congestion, or jitter; or service provider name or type. In addition to network information, other types of contextual information can be gathered, including the type of client device and the type of audio or video interfaces available to the user. The information may be carried within the body of the request or it may be carried as network protocol information, such as in packet headers. Based on the request, the video conference provider 310 may determine that the user is connected to the internet via a satellite or cellular network service provider that supplies internet access to an airline, a rail network, an autonomous vehicle supplier, or other contexts.

For example, an airline may contract with a satellite internet service provider (“ISP”) to provide internet service on its commercial flights. When a user connects to the virtual conference provider 310 via such an ISP, the virtual conference provider 310 may determine that the client device's network address is associate with such an ISP and therefore determine that the client device is on a commercial aircraft. It may further determined the type of vehicle based on the ISP, such as narrow-body or regional aircraft, which may typically have a cellular-based ISP, or wide-body or long-range aircraft, which may typically have a satellite-based ISP. The same type of analysis may be performed with respect to networking services provided on other forms of transportation, including rail, bus, or autonomous vehicle. Each of these may provide internet service via an established ISP. Thus, the virtual conference provider 310 can determine the type of vehicle the client device is travelling in based on such information.

In addition to determining a vehicular context, the virtual conference provider 310 may detect other contextual information, such as available audio or video capture devices. If a user is on a commercial flight, they may have a webcam on their client device and have a headphone with a microphone to enable audio communications. Information about these devices may be included with the request or with subsequent communications with the virtual conference provider 310. Similarly, if the user is travelling in an autonomous vehicle, their client device may connect with microphones or cameras positioned within the vehicle to provide audio and video interfaces available to its communications systems. In addition, based on the types of audio or video interfaces, the virtual conference provider 310 may be able to determine a certification status of such equipment. For example, airline regulatory bodies, such as the United States' Federal Aviation Administration, may only allow the use of certain audio or video equipment onboard commercial aircraft, such as to avoid disturbing other passengers or preventing interference with other onboard equipment or announcements. Thus, based on the types of such equipment, the virtual conference provider 310 can determine whether the available equipment satisfies applicable regulations. Thus, the virtual conference provider 310 can determine rich contextual information about the client device.

After determining a context for the client device 350, the virtual conference provider 310 can generate a manifest for the client software 360 that establishes certain operational configurations to enable, disable, or restrict use of certain functionality otherwise provided by the client software 360. For example, if the client device 350 is on a commercial flight, but lacks certified audio and video equipment, the virtual conference provider 310 may generate a manifest that configures the client software 360 to disable access to the available microphone and camera. It may also disable access to the speakers, such as if the user lacks headphones. The virtual conference provider 310 may also mandate the use of transcription services, such as real-time transcription, with a corresponding overlay of captions, or it may activate chat functionality and provide a visible chat window for the user to interact with. In addition, the virtual conference provider 310 may use received network information to adjust audio or video settings to accommodate limited bandwidth. For example, based on network information, the virtual conference provider 310 may generate a manifest that restricts video or audio streams transmitted by the client device to a specific resolution or bitrate, such as to accommodate limited bandwidth contexts. The manifest may be generated to include other information, such as to confirm its authenticity via a cryptographic signature or to confirm complete reception of the manifest such as via a hash value, and then transmitted to the client device 350.

After receiving the manifest 390, the client device 350 may confirm the authenticity and integrity of the manifest, such as by verifying the signature or the hash, and then extract and apply one or more configuration settings. For example, it may disable audio and video capture and also disable graphical user interface (“GUI”) features associated with those features to prevent the user from activating them. It may also select specific audio or video encoders or enable certain conferencing functionality, such as transcripts or chat. At a later time, when the user joins a virtual conference, these configurations may be imposed and the user may attend the virtual conference, though with restricted interactive functionality. In some examples, the manifest may wholly disable virtual conference capabilities. Instead, the manifest may limit the virtual conferencing application to engaging in text communications, such as via one or more chat channels.

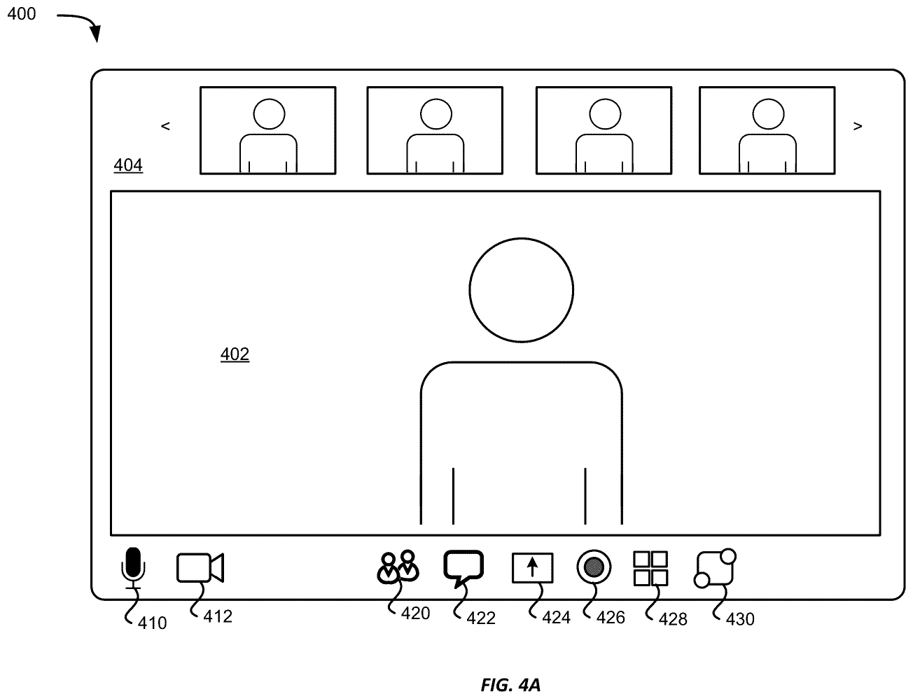

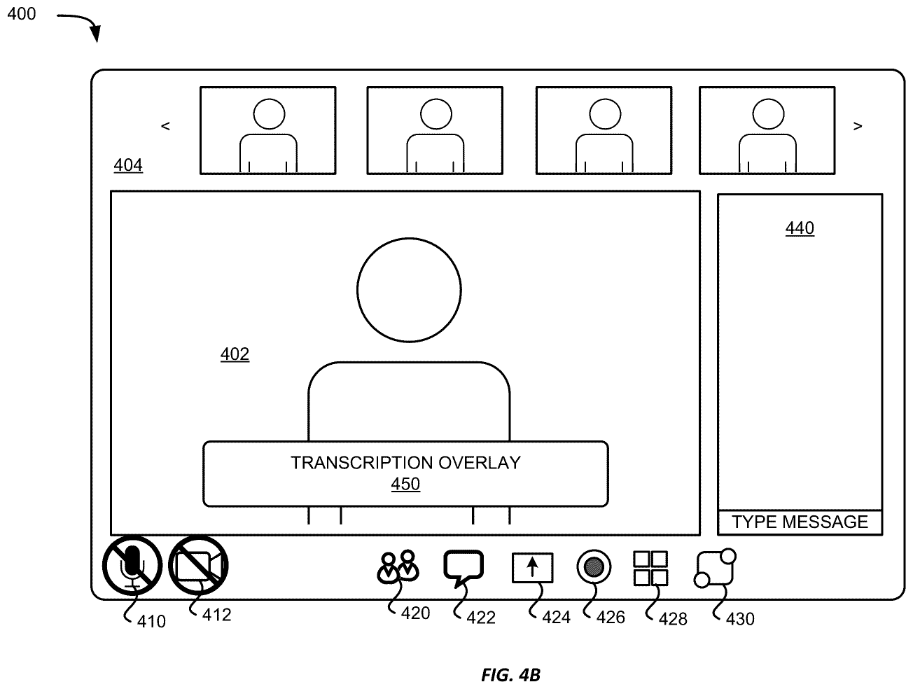

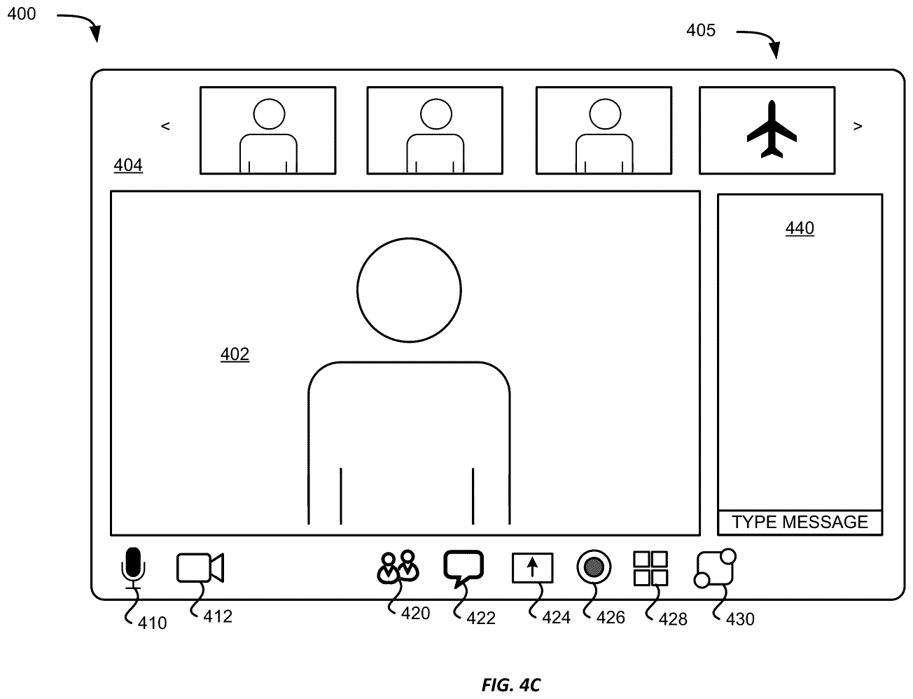

Referring now to FIGS. 4A-4C, FIG. 4A shows an example GUI 400 for a software client that can interact with a virtual conference provider, such as virtual conference provider 310, to allow a user to connect to the virtual conference provider 310, chat with other users, or join virtual conferences. A client device, e.g., client device 350, executes a software client as discussed above, which in turn displays the GUI 400 on the client device's display. In this example, the GUI 400 includes a speaker view window 402 that presents the current speaker in the virtual conference. Above the speaker view window 402 are smaller participant windows 404, which allow the participant to view some of the other participants in the virtual conference, as well as controls (“<” and “>”) to let the host scroll to view other participants in the virtual conference.

Beneath the speaker view window 402 are a number of interactive elements 410-430 to allow the participant to interact with the virtual conference software. Controls 410-412 may allow the participant to toggle on or off audio or video streams captured by a microphone or camera connected to the client device. Control 420 allows the participant to view any other participants in the virtual conference with the participant, while control 422 allows the participant to send text messages to other participants, whether to specific participants or to the entire meeting. Control 424 allows the participant to share content from their client device. Control 426 allows the participant toggle recording of the meeting, and control 428 allows the user to select an option to join a breakout room. Control 430 allows a user to launch an app within the virtual conferencing software, such as to access content to share with other participants in the virtual conference.

A user may interact with such a GUI 400 when their client software is operating in a normal configuration, such as while at home or in an office. Thus, the user has full control over their audio and video settings, can freely chat with other participants, and can use any suitable audio or video encoders to provide high quality audio and video streams to other participants in a virtual conference. However, in other scenarios, the GUI 400 may be restricted to only allow certain functionality or to disable certain functionality.

Referring now to FIG. 4B, FIG. 4B shows a view of the GUI 400 in an example when the user's client device 350 has received a manifest 390 from the virtual conference provider 310. In this example, the manifest 390 included configuration parameters that disabled access to the client device's microphone 356 and camera 354. The GUI 400 informs the user that these devices have been disabled by disabling the microphone and camera options 410-412 in and by providing indicators that they have been disabled. In this example, each of the microphone and camera options 410-412 have been overlaid with the “no” symbol, though in other examples, the options 410 may be greyed out or omitted from the GUI 400.

In addition, the GUI 400 has opened a chat window 440 on the right side of the GUI 400, within which the participants may exchange chat messages. Since the user of the client device 350 is not able to interact with the other participants using voice or video, the chat window 440 can allow the user to interact with the other participants via text messages. In this example, the virtual conference provider provides an indication, such as a manifest, to the other participants' client devices to cause the GUIs presented at the participants' client devices to display a chat window so that they can more readily see chat messages sent by the user.

In addition, the manifest 390 has also disabled audio output by the client device 350, but has activated transcription functionality for the meeting, which is then overlaid in real-time in the transcription overlay window 450. In this example, transcription is performed by the virtual conference provider 310, which then provides a real-time transcript to the participants in the virtual conference, if requested. For the user, since their audio output is disabled, the real-time transcription can allow the user to understand what is being discussed in the virtual conference. In combination with the chat window 440, real-time transcription can allow the user to fully participate in the virtual conference, despite being unable to use audio or video inputs.

Referring now to FIG. 4C, FIG. 4C shows the GUI 400 in which another of the participants has joined the virtual conference while travelling on an airplane as well. Similar to the user of user device 350, the other participant has had their audio and video inputs disabled by a manifest and is instead represented by an airplane icon 405. Thus, the other participants in the virtual conference can immediately tell that the participant is joining from an airplane and likely has reduced communication capabilities. Further, because that participant is joining from such a context, the video conference provider transmits an indication, such as a manifest, to the other participants' client devices to display a chat interface. As a result, the GUIs of all of the other participants also display a chat window 440 so that they can more easily see when the participant has entered a chat message, as discussed above. Thus, the GUI 400 has presented information to both provide the other participant's context, but also to engage in discussions with the participant via the chat window 440.

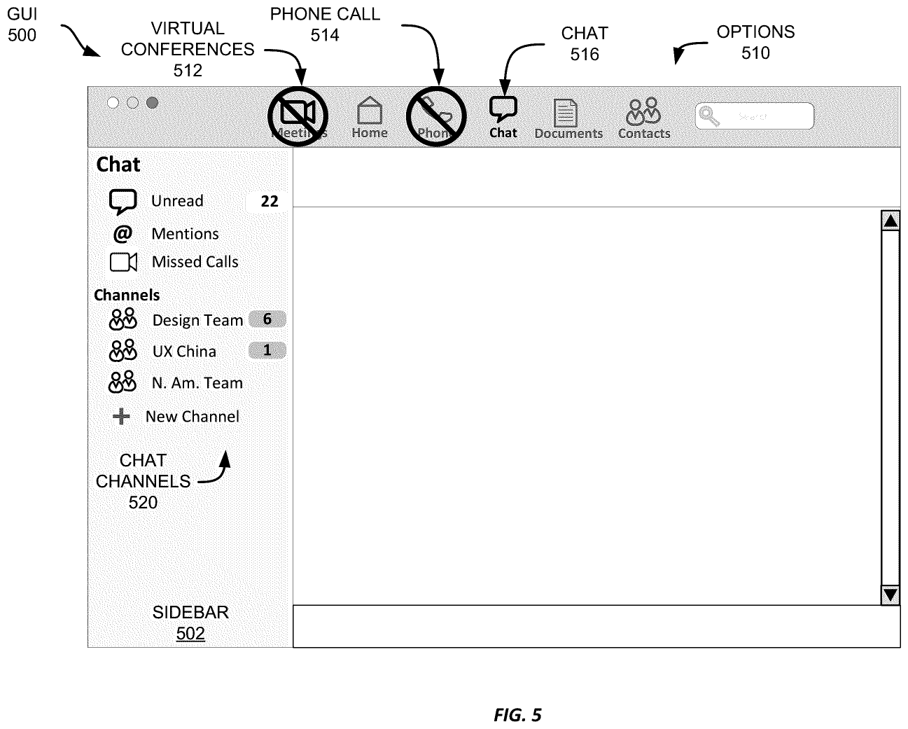

Referring now to FIG. 5, FIG. 5 shows an example GUI 500 for the virtual conferencing software 360 that allows the user to interact with a variety of functionality offered by the virtual conference provider 310. In this example, the GUI 500 has a variety of options 510, including virtual conferences 512, phone calls 514, and chat functionality 512. In this example, the manifest 390 received by the client device 350 has entirely disabled video conference and phone call functionality 512-514 in the virtual conferencing software 360. As can be see in the options list, both the virtual conference option 512 and the phone call option 524 have been disabled and are indicated as such by overlaid “no” symbols. However, the manifest 390 does not disable the chat functionality, thus the chat icon 516 remains enabled and the user is able to interact with any of the available chat channels 520 presented in the sidebar 502 of the GUI 500. In examples where virtual conferencing or phone calls remain available, but with limited functionality, an indicator may be displayed to illustrate that the function is available by limited. For example, a red exclamation mark (“!”) may be displayed adjacent to the affected functionality. Thus, the user can be immediately informed of which functionality remains available and what limitations may have been imposed. In addition, other participants attempting to interact with the user may be provided with an airplane icon, or other suitable icon, for the user's status to indicate that the user is operating in a particular context.

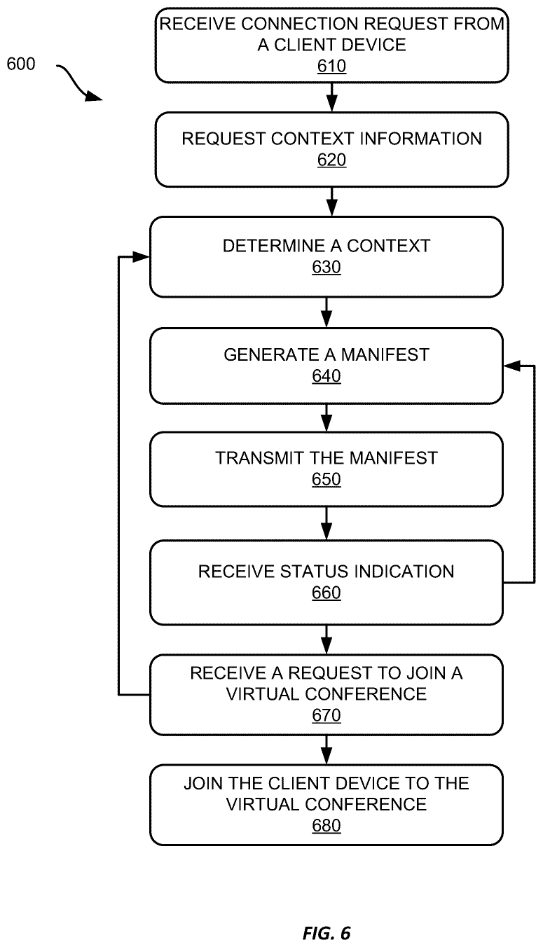

Referring now to FIG. 6, FIG. 6 shows an example method 600 for remote management of client devices for virtual conferences based on client device context. This example method 600 will be described with respect to the system 300 shown in FIGS. 3A-3B, but any suitable system according to this disclosure may be used, including the systems 100-200 shown in FIGS. 1-2.

At block 610, a virtual conference provider 310 receives a connection request from a client device 350. In this example, the client device 350 launches a virtual conferencing application 360, which obtains access credentials from the user. The virtual conferencing application 360 then transmits a connection request to the virtual conference provider 310, including the access credentials via the intervening satellite ISP and communications network 320. However, as discussed above with respect to FIGS. 3A-3B, while the client device 350 in this example is located on an airplane and connects to the communications network 320 via a satellite ISP, other examples may include the use of other types of networks, such as cellular, 5G, etc. In addition, contexts may include other types of transportation settings, such as rail, bus, car, or autonomous vehicle.

At block 620, the virtual conference provider 310 may request context information from the client device 350. For example, the virtual conference provider 310 may receive some information from the client device 350 indicating a potentially restrictive context, such as a network address indicating an ISP associated with an airline. However, the virtual conferencing software 360 may not send other context information unless requested. Thus, after determining that the client device 350 may be on an aircraft, the virtual conference provider 310 may request more fulsome context information, which may include network information, client device information, audio and video input and output device information, location information (including speed), and any other suitable context information to enable the virtual conference provider 310 to determine an accurate context for the client device 350.

At block 630, the virtual conference provider 310 determines a context associated with the client device 350 based on the request. As discussed above, the request may include information provided by the virtual conferencing application, such as the user's login credentials, the type of client device being used, or information about audio or video capture devices. The request may also include other information that is provided by the client device or carried with network protocol information, such as network address, network type, network status, or ISP information. The virtual conference provider 310 may use some or all of such received information to determine a context associated with the client device 350.

For example, the virtual conference provider 310 may determine the identity of an ISP providing network access to the client device 350. It may then search a datastore to identify one or more entities associated with the ISP, such as airlines, rail services, public transportation, or autonomous vehicle providers. Based on the ISP, the virtual conference provider 310 may determine a type of vehicle the client device 350 is traveling on, such as an airplane, train, bus, or autonomous vehicle. This information may provide at least a portion of the client device's context.

In addition to means of travel, the virtual conference provider 310 may obtain other types of information, such as location, network status information, and types of audio or video input devices. Network status information may include bandwidth, latency, jitter, dropped packets, route, or ping. Such information may provide contextual information related to the ability of the client device 350 to send or receive multimedia streams for virtual conferencing. Location may be obtained from an onboard positioning device, such as a GPS receiver, or may be determined based on network information, such as a network address. The location may indicate a security of a network connection or mode of transportation. For example, location may include an altitude or a location remote from any population centers, which may indicate a reduced bandwidth connection or that the client device 350 is located on an aircraft. The location information may also indicate speed information, which may indicate air travel or high-speed rail travel, such as if the speed is greater than 100 or 200 miles per hour.

Regarding audio or video input or output devices, as discussed above, certain modes of transportation may have regulations covering the types of audio and video devices permitted for use with audio or video conferencing. Thus, such information may help establish the context for the client device 350. For example, the virtual conference provider 310 or governing laws or regulations may require the use of a headset to access audio output from a virtual conference or require the use of a headset with an integrated microphone to provide audio input to a virtual conference, such as to prevent inadvertently recording nearby passengers. Similarly, some contexts may prohibit the use of a video capture device, which may also inadvertently capture nearby passengers.

At block 640, the virtual conference provider 310 generates a manifest 390 for the client device 350. In this example, the virtual conference provider 310 selects a manifest for the client device 350 from a set of pre-configured manifests based on type of transportation. For example, the virtual conference provider 310 may have different pre-configured manifests for each of air travel, rail travel, autonomous vehicle travel, and bus travel. Based on a determined type of vehicle, the virtual conference provider 310 may select the corresponding manifest. Similarly, the virtual conference provider 310 may have different pre-configured manifests for different types of vehicles, such as wide-body versus narrow-body aircraft or interstate rail versus light rail service. Different types of vehicles may have different types of associated network connections and thus may have different capabilities with respect to virtual conferencing.

In some examples, the virtual conference provider 310 may generate a manifest by establishing settings based on the client device's context, which may be based on a type of vehicle, applicable regulations, network conditions, location, available audio and video devices, etc. Thus, it may determine whether applicable regulations allow the use of audio or video capture, whether the network conditions allow video as well as audio, or whether video needs to be of a particular quality. It may also determine whether audio or video may be provided both from the client device 350 and to the client device 350, or only in one direction. For example, the virtual conference provider may prioritize sending audio and video streams to the client device 350 and allocate bandwidth to such multimedia streams from an available amount of bandwidth for the client device 350. Depending on remaining available bandwidth, the virtual conference provider 310 may identify a specific audio or video encoder for the client device 350 to use, or to disable video or audio or both. It may also determine whether to enable chat or transcription functionality based on whether audio or video streams are provided to the client device 350.

In some examples, the virtual conference provider 310 may determine that the context should prohibit the client device 350 from joining any virtual conferences and includes a setting in the manifest to disable video conferencing in the virtual conferencing software 360, such as in contexts with low bandwidth, high latency or jitter, high packet loss, or other networking issues. Alternatively, the virtual conference provider 310 may determine that the type of device is unsuitable for virtual conferencing based on the context, such as if the client device is a smartphone. In such a case, it may be impractical for a user to interact with a virtual conference if audio and video inputs are disabled. Thus, the virtual conference provider 310 may configure the virtual conferencing software 360 to disable access to virtual conferencing until the context changes.

At block 650, the virtual conference provider 310 transmits the manifest to the client device 350. In this example, the manifest is transmitted as a datafile, however, in some examples, the virtual conference provider 310 may transmit individual settings in one or more messages to the virtual conferencing software 360. Alternatively, in some examples, the virtual conferencing software 360 may have one or more pre-configured manifests stored locally and the virtual conference provider 310 may provide an identification of the manifest to use.

At block 660, the virtual conference provider receives a status indication from the client device 350. The status indication may indicate a change in context, such as a change in audio or video capture devices after the user plugs in a camera or headphones and a microphone, or if a change in ISP has been determined. In response to receiving the status indication 660, the method returns to block 640. Otherwise, the method proceeds to block 670.

At block 670, the virtual conference provider 310 receives a request to join a virtual conference from the client device 350. If the virtual conference provider 310 has not yet determined a context, the method may return to block 620 or 630 to request context information or determine a context for the client device 350. If the context indicates that virtual conferencing should be disabled for the client device 350, the virtual conference provider 310 may deny access to the virtual conference. Such a scenario may occur if the client device 350 requests access to a virtual conference before the virtual conference provider 310 has determined a context. Otherwise, the virtual conferencing software 360 may be configured by a manifest to disable access to virtual conferences before a request is sent to the virtual conference provider 310.

At block 680, the virtual conference provider 310 joins the client device 350 to the virtual conference generally as discussed above with respect to FIGS. 1-2.

The example method 600 discussed above has been described in a particular order, however, it should be appreciated that different orderings of the blocks may be suitable for other examples. For example, block 670 may occur before blocks 620 or 630. Further, some examples may omit one or more blocks, such as by omitting block 660.

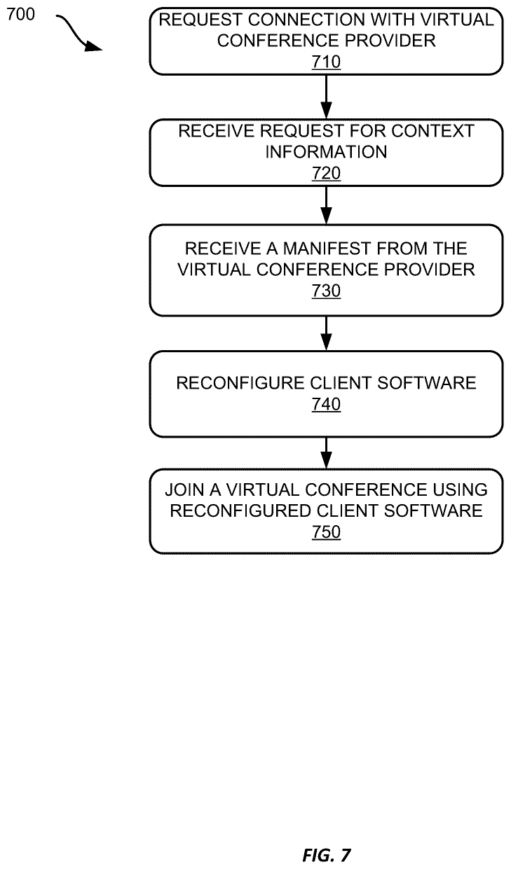

Referring now to FIG. 7, FIG. 7 shows another example method 700 for remote management of client devices for virtual conferences based on client device context. This example method 700 will be described with respect to the system 300 shown in FIGS. 3A-3B, but any suitable system according to this disclosure may be used, including the systems 100-200 shown in FIGS. 1-2.

At block 710, virtual conferencing software 360 executed by a client device 350 requests a connection with a virtual conference provider 310. In this example, a user has launched the virtual conference software 360 on their client device 350 and has entered credentials to access their account with the virtual conference provider 310. After receiving the credentials, the virtual conferencing software 360 communicates with the virtual conference provider 310 and requests a connection and access to the user's account. It should be appreciated the receiving credentials is not required and a user may attempt to access the virtual conference provider 310 without accessing account, such as to join a virtual conference anonymously. In some such examples, the virtual conferencing software 360 may transmit a request to the virtual conference provider 310 without any login credentials. Further, login credentials may not be requested until after the virtual conferencing software 360 has requested a connection with the virtual conference provider 310 in some examples.

In some examples, the request may include information about the client device 350, audio or video capture devices, network status or capabilities, or audio or video output devices. The request may also request location or navigation information, such as latitude, longitude, speed, heading, and other information that may be available from a GPS receiver or other locationing system available within or to the client device, such as cellular-based location information like trilateration. It may also include other information inserted by networking software executing on the client device 350, such as a protocol stack that might generate network packets that include information such as a network address.

At block 720, the virtual conferencing software 360 receives a request for context information from the virtual conference provider 310. In response to the request, the virtual conferencing software 360 may generate and transmit a response to the request that includes context information, such as the context information discussed above with respect to blocks 620-630.

At block 730, the virtual conferencing software 360 receives a manifest 390 from the virtual conference provider. The manifest includes one or more configuration settings for the virtual conference software, including configurations for audio or video input or output devices, audio or video encoder settings, transcription settings, chat settings, accessibility to virtual conferencing, or any other suitable configuration setting.

At block 740, the virtual conferencing software 360 reconfigures its functionality based on the manifest. For example, it may disable audio or video input or output devices, or select particular audio or video encoders, and it may also disable one or more user interface options to enable such devices. The virtual conference software 360 may also enable or request transcription services when joining a virtual conference as well as enable captions with real-time transcription information. It may also enable and display chat functionality associated with a virtual conference the user is attending, or it may disable the option to join a virtual conference within the GUI 500. Still any other configuration setting may be adjusted based on a received manifest.

At block 750, the virtual conferencing software 740 joins a virtual conference using the configurations established by the received manifest. As discussed above with respect to block 670, if a manifest was received after the user has attempted to join a virtual conference and the manifest indicates that virtual conference access should be disabled based on the client device's context, the virtual conference provider 310 or the virtual conferencing software 360 may deny access to the virtual conference.

The example method 700 discussed above includes a sequence of blocks performed in a particular order; however, no such order is required and, further, not all blocks must be performed in all cases. For example, blocks 720 and 750 may be omitted in some examples. Further, block 750 may occur before blocks any or all of blocks 720-740.

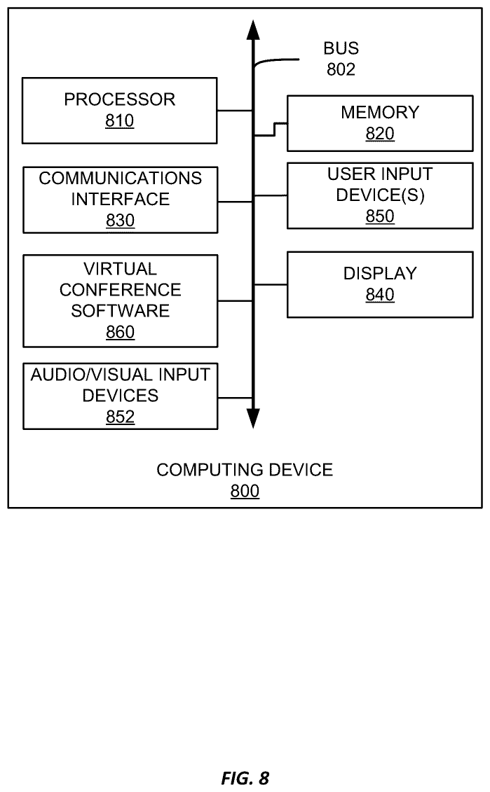

Referring now to FIG. 8, FIG. 8 shows an example computing device 800 suitable for use in example systems or methods remote management of client devices for virtual conferences based on client device context according to this disclosure. The example computing device 800 includes a processor 810 which is in communication with the memory 820 and other components of the computing device 800 using one or more communications buses 802. The processor 810 is configured to execute processor-executable instructions stored in the memory 820 to perform one or more methods for remote management of client devices for virtual conferences based on client device context according to different examples, such as part or all of the example methods 600-700 described above with respect to FIGS. 6-7. The computing device 800, in this example, also includes one or more user input devices 850, such as a keyboard, mouse, touchscreen, microphone, etc., to accept user input. The computing device 800 also includes a display 840 to provide visual output to a user.

In addition, the computing device 800 includes a virtual conferencing application 860 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 800 also includes a communications interface 840. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP. While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by a virtual conference provider, a connection request from a first client device executing virtual conference client software;
determining a context associated with the first client device based on the request;
generating a manifest associated with the context, the manifest comprising one or more configuration settings associated with the virtual conference client software; and
transmitting the manifest to the client device.

2. The method of claim 1, wherein the connection request includes a request to join a virtual conference; and
after transmitting the manifest to the client device, joining the client device to the virtual conference.

3. The method of claim 1, wherein the one or more configuration settings comprise one or more of microphone access, camera access, video resolution, video bitrate, transcription settings, or caption settings.

4. The method of claim 1, wherein determining the context comprises determining a network provider associated with the request.

5. The method of claim 1, wherein determining the context comprises determining a location of the client device.

6. The method of claim 1, wherein determining the context comprises determining a type of audio or video input device associated with the first client device.

7. The method of claim 1, wherein determining the context comprises determining parameters of a network connection of the first client device.

8. The method of claim 1, wherein a plurality of client devices are connected to the virtual conference provider, and further comprising providing an indication of the context to a subset of the client devices of the plurality of client devices, the indication configured to cause the plurality of client devices to display a visual indicator of the context.

9. The method of claim 8, wherein the visual indicator is associated with one of a chat session or the virtual conference.

10. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
receive a connection request from a first client device executing virtual conference client software;
determine a context associated with the first client device based on the request;
generate a manifest associated with the context, the manifest comprising one or more configuration settings associated with the virtual conference client software; and
transmit the manifest to the client device.

11. The system of claim 10, wherein the connection request includes a request to join a virtual conference, and wherein the one or more processors are configured to execute further processor-executable instructions stored in the non-transitory computer-readable medium to, after transmitting the manifest to the client device, join the client device to the virtual conference

12. The system of claim 10, wherein the one or more configuration settings comprise one or more of microphone access, camera access, video resolution, video bitrate, transcription settings, or caption settings.

13. The system of claim 10, wherein the one or more processors are configured to execute further processor-executable instructions stored in the non-transitory computer-readable medium to determine a network provider associated with the request.

14. The system of claim 10, wherein the one or more processors are configured to execute further processor-executable instructions stored in the non-transitory computer-readable medium to determine a location of the client device.

15. The system of claim 10, wherein the one or more processors are configured to execute further processor-executable instructions stored in the non-transitory computer-readable medium to determine a type of audio or video input device associated with the first client device.

16. The system of claim 10, wherein the one or more processors are configured to execute further processor-executable instructions stored in the non-transitory computer-readable medium to determine parameters of a network connection of the first client device.

17. A non-transitory computer-readable medium comprising processor-executable instructions configured to cause one or more processors to:
receive a connection request from a first client device executing virtual conference client software;
determine a context associated with the first client device based on the request;
generate a manifest associated with the context, the manifest comprising one or more configuration settings associated with the virtual conference client software; and
transmit the manifest to the client device.

18. The non-transitory computer-readable medium of claim 17, further comprising processor-executable instructions configured to cause one or more processors to, in response to determining the context, transmit a chat indication to participants in the virtual conference, the chat indication configured to cause client devices associated with the participants to display a chat interface.

19. The non-transitory computer-readable medium of claim 17, wherein generating the manifest comprises selecting the manifest based on the request.

20. The non-transitory computer-readable medium of claim 17, further comprising processor-executable instructions configured to cause one or more processors to:
receive a status indication from the first client device;
determine a new context based on the status indication;
generate a second manifest based on the new context; and
transmit the second manifest to the client device.
